(19) United States
(12) Patent Application Publication
(10) Pub. No.: US 2010/0119068 A1
(43) Pub. Date: May 13, 2010

(54) Digital File Anti pirating

(76) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(21) Appl. No.: 12/268,970

(22) Filed: Nov. 11, 2008

(51) Int. Cl. H04K 1/00; H04L 9/00

(52) U.S. Cl. 380/251; 713/182

(57) ABSTRACT

A digital file system where the files are encrypted and are decrypted for playing by using a specified decryption key. The decryption key can be personalized, e.g., to a machine, to a user, to a location or some other personalization.

### BACKGROUND

Software developers spend considerable sums of money developing the software that they intend to later sell to the public. They recoup their development money by selling the products to the public. Another reason is that it is very easy to copy software, since it is just a digital file and can be digitally copied. Illegally copied software deprives the software developer of income. Consequently, software developers go to great lengths to prevent illegal copying of the software.

When the software is executed on a general purpose computer such as a PC, the software may use some form of anti-copying, e.g. requiring the actual printed CD or other media to be in the drive, requiring some kind of validation of the program, or requiring some other technique to ensure the reliability of the product. However, sufficiently determined hackers can almost always get around these systems. Moreover, some countries, and most notably South American countries, often do not police copyright infringement. The government failure to police makes it even easier for an illegal copier or pirate to produce these kinds of illegal software products. For example, illegal copies of game console software may be freely sold in some South American countries.

This, however, needs to be balanced against the inconvenience that is caused to legitimate users by the anti-pirating techniques. Say a user has legitimately purchased a game. That user might want to play it on their own console, and they might want to play it on someone else's console. It is undesirable to cause inconvenience to those who have actually paid for the game.

Digital Rights Management or DRM may encrypt media files. Many members of the public has opposed DRM based on its restriction of a legitimately purchased file.

### SUMMARY

The present application describes a wholly new way of distributing digital files, e.g., game software or media files to users.

According to an embodiment, all or part of a digital file is encrypted. Only those who have the actual decryption key can use that software. The digital file that forms the game may be present on any of a number of different computers. Accordingly, the license does not rely on having the media, and hence even if the CD or other media is damaged, the user can still use the paid-for game. Moreover, by using encryption techniques which are appropriately tied to the machine, it becomes cryptographically impractical for anyone to produce a pirated copy or to use the digital file without paying for the use of the digital file.

### BRIEF DESCRIPTION OF THE DRAWINGS

In the Drawings:

FIG. 1A and 1B show a special purpose computer which can be used to read the special encrypted files that are described according to the embodiments;

FIG. 2 shows a block diagram of a system that allows interfacing with the special files described in the embodiments;

FIG. 3 shows a flowchart of operation; and

FIG. 4 shows a system where the dongle function can be carried out using a wireless device.

### DETAILED DESCRIPTION

A number of different embodiments are described herein. These embodiments may be used with a number of different kinds of machines that operate and produce their content files, including a game console, a desktop computer, or a laptop computer, with a book reading computer or a mobile phone, or with any other kind of computer. For example, the book reading device can be a specialized bookreader such as the Amazon Kindle or Sony PRS-505 e-book reader.

According to an embodiment, a plurality of digital interactive file sets, e.g. games or book files, are stored in each of a plurality of different devices in encrypted form. Each file set includes one or more files that collectively forms an interactive playable application, e.g., a game or an ebook. The application is interactive based on inputs to said computer system. The playable item is controlled by a user via an IO device such as a game controller or a nextpage/previous page keyset, to change characteristics of a displayed output. The encrypted file sets produce outputs based on those controls. The computer cannot play a complete game or book without an decryption key associated with said encrypted file set.

According to an embodiment, these files are synced into the devices, so that each of the devices may store a desired set of files. The main “server”, For example, can determine different groups of files which should be present on different items. These files can be sent directly to the other units such as 149, or for larger files, by peer to peer connection. A main server 99 may determine the set of files to be stored by all the computers.

Another embodiment ships the computers with files installed, and may allow users to download additional files and/or receive files on a media such as a DVD/CD/USB device.

Either the whole file, or just a part of the file, is encrypted. The unencrypted part of the file may allow playing a feature-reduced version of the file, e.g, a feature reduced game, or may show a preview for example of a game or a book or a movie. Each of a plurality of different devices may receive the same file, but not all of the devices can play that file completely. Users can pay to get decryption keys that can be used to play the files. In one embodiment, a user with an appropriate decryption key can play the encrypted game on any of the computers: 100 or 149.

Another embodiment may have a separate area that stores the user's “personal” files, e.g., those that the user has already purchased, for example.

Another embodiment may provide different sets of files to different devices. For example, 500 GB devices may get file subset x. 1 TB devices may be synced to received subset x and also subset y beyond subset x.

Another embodiment may use a user's previous selections and likes/dislikes to determine a set of files to be stored on the unit.

Another embodiment may change the game files for each of a plurality of machines to reflect the license that is purchased by a user.

According to an embodiment, the files that are used by the computer are cryptographically encoded in a way that prevents them from being used without an appropriate decryption key.

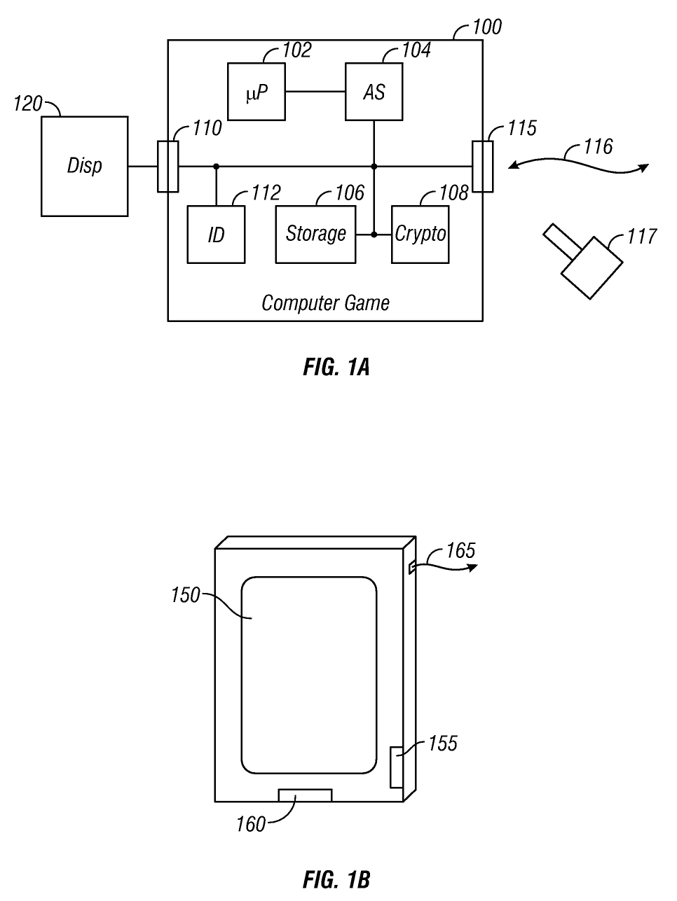

FIG. 1A shows a computer that operates a computer game. The computer 100 may include a processor 102, associated circuitry such as 104 that can include a video driver as well as I/O drivers, a storage unit such as 106, and a cryptographic circuit 108. The output of the computer 110 may be displayed on the display 120. The display is shown as being separate from the computer, but in certain kinds of computer games may be attached to the computer. For example, in some embodiments, the computer may be a handheld computer game such as a “Game Boy” and may have built-in I/O and other features.

The computer system 100 also includes a port 115. The port may be wireless or wired, and may be a USB port, or wireless ethernet, or the like. In one embodiment, shown in figure IA, updates to the files (e.g., game updates) may be obtained over a wireless communication network 116. Also, a USB device such as 117 may be connectable with port 115, and may allow communications via that port. Another embodiment, shown in FIG. 1B, is for an automated book reading device. These devices include a built-in screen such as 150, a port for receiving the books on chip 155, and certain kinds of reading control shown generically as 160. In addition, this embodiment uses a network connection shown as 165. The device of FIG. 1B includes the same basic structure as in FIG. 1A, including a processor, storage unit and cryptographic device much as in the FIG. 1A embodiment.

The computers 100, 149, 150 may be special-purpose computers in that they may be used only by a single kind of program (a gaming console or a book reading computer) or alternatively, they may be general purpose computers that are capable of multiple different operations including not only playing a game etc. but also doing some other things.

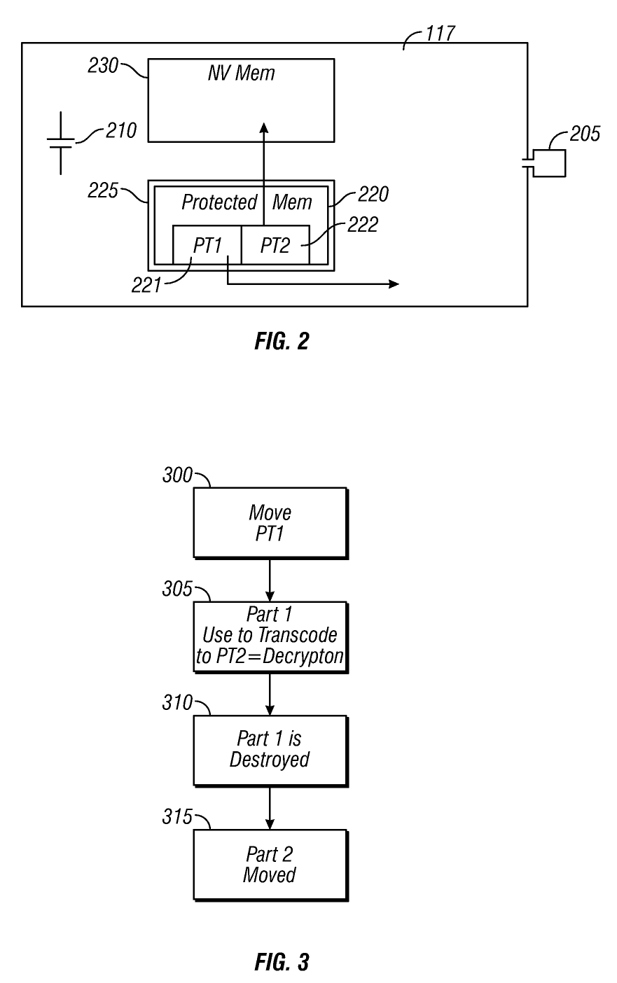

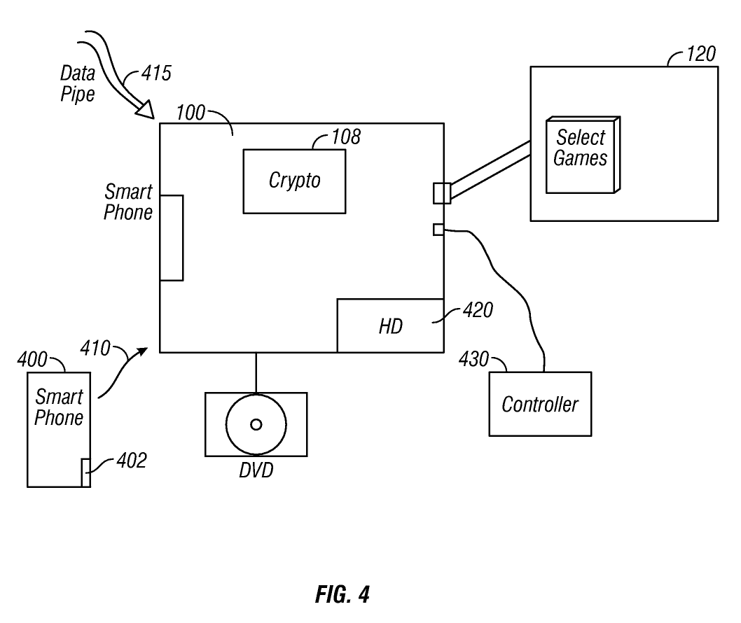

In one embodiment, a “dongle” device 117 stores a decryption key to decrypt one or more of the stored encrypted files. FIG. 2 illustrates the dongle 117, including a memory 220, that may be cryptographically protected. The dongle may be a USB-based device as shown with a USB port 205, or may be a device that communicates wirelessly. In one embodiment, the dongle may be an active RFID type device.

The device may also be a hybrid wired and wireless device. In the hybrid embodiment, the device includes a battery 215, and also includes a USB connector 205. In operation, the battery 215 may be charged whenever the device is connected to a source of USB power.

Another embodiment may use a solar cell on the device, and where the device only operates based on light, requiring the user to use the device in a light environment.

According to an embodiment, the dongle holds cryptographic codes that can be used to decrypt, and hence play, the games stored in the storage area 106 of the computer.

In one embodiment, the dongle stores decryption codes in a way that prevents those codes from being re-determined from anywhere outside the dongle. There are two different memories in the dongle 200: a working memory 205, and a protected memory 206. The dongle codes in protected memory 206 are codes that decode digital files such as games and books that are stored in the storage unit 106 of the computer game.

For many of the embodiments, the operation will be described for a computer game, but it should be understood that the operation can be similarly applied to any digital file. According to an embodiment, the dongle stores codes, and each code in the dongle can be used to play one specified game. The codes can be written into the dongle by the manufacturer, or can be added by the user.

According to an embodiment, the codes in the dongle are not usable until they are “personalized” using a technique that combines the code in the dongle with some feature indicative of the specific user, e.g., the user personally, or the user's console. The codes are cryptographically protected so that they can only be used once. The codes can be obliterated after they have been used once. In this case, part of the dongle code is used to modify the program so that it can be used with another part of the code. For example, the dongle program may include a first part that relies on a cryptographic key to decode the stored game in the computer in a way that allows it to be decoded by the second part. The first part of the dongle code is used to modify the game that is stored or the digital file of the game that is stored in storage unit 106. It modifies this code to create a new encrypted code. That encrypted code can then be decrypted by the second part of the dongle storage.

A first embodiment described a dongle embodiment. The dongle may be a USB device, or a device with wireless capabilities. In one embodiment, the dongle may be powered either from externally applied power, such as from the USB port 205, or alternatively powered from an internal battery 210. The battery may also be replaceable, and may also be charged from power from the USB port. An alternative embodiment may use wireless devices, such as RFID technology, and the like.

An embodiment uses the dongle to store special codes that can be used to play the games, once properly activated. The games in this embodiment, for example, are initially stored in the storage unit in an encrypted form. These encrypted games include the full code of the game. However, either none of that game, or only a small part of that game can be played because a decryption code is not present.

In an simplest embodiment, the dongle 117 may include a decryption code for the game that can be used whenever the dongle is present.

Other embodiments recognize that no matter how secure the devices may be, there is always a chance that this decryption code might be intercepted by another, and copied to allow pirated game use. One embodiment may allow use of many different codes, and may decommission certain codes when they are intercepted, and provide registered users with new codes.

A particular embodiment uses a two-part code, to form a special decryption key. The computer may operate according to the flowchart of FIG. 3. The dongle comes shipped with a special protected memory shown as 220. This may be protected, for example, using known cryptographic boundaries such as described in U.S. Pat. No. 6,986,053, or using other techniques which may make it difficult for someone to read the contents of the protected memory.

The cryptographic device 100 stores a key that can be used to read the protected memory. A two part code is stored within the protected memory, including part 1 (221) and part 2 (222). The two-part code goes together. According to the embodiment, the cryptographic unit moves part one of the code at 300. Part one is moved, not read, so that after moving, it is no longer in the dongle for later use. The cryptographic boundary 225 may be constructed in a way that prevents part one and part two from being read, but rather only allows these to be moved.

After part one is moved at 300, it is used at 305 by the cryptographic device to transcode either the encrypted software or the key itself. The term “transcode” in this embodiment refers to taking a file that is encrypted in a way that can be decrypted using key 1; decrypting that file using key 1; and re-encrypting the file in a way that allows the file to be decrypted using key 2. In an embodiment, the software in 106 is transcoded into a new encrypted software of a type that can be read by using the part two decryption key. Part 1 may be a private key of a public/private key decryption software, which may be used to decrypt the software in the storage device 106, and may also include a new decryption key that can be corresponding to part two.

After the transcoding of 305, part one is destroyed by the cryptographic device 108. Part 2 then becomes the new decryption key for the software in the storage 106, and is moved to the nonvolatile memory 230. Part 2 may also be moved to other places, including to the storage unit in the computer game. In one embodiment, the number of moves of the decryption key may be limited.

In another embodiment, the transcoding may require both the part 2 decryption code, and also some individualization code, e.g., a user's biometric information, a personal identification number or PIN, and/or a processor ID for the individual computer that will read the new encrypted file.

The user may receive the ability to store a number of different decryption part 2s into the nonvolatile memory 230, so that the single dongle can be used for a number of different game decryptions.

Another embodiment may add personalization to the encryption/decryption rather than “transcoding” as in the above, e.g, by concatenating.

According to an embodiment, the game stored in the storage unit 106 is only partially encrypted, where certain parts of the game are stored unencrypted. For example, the game engine may be encrypted, or other parts of the game may be unencrypted. According to a certain function, only certain functions can be played on the unencrypted game, while after the unencrypted game while to play the other functions you need the decryption key. This has two advantages—it may speed up the reading of the game since parts of the reading are unencrypted. It may also allow playing parts of the games as “previews”. Another embodiment may encrypt the entire game.

The game 100 may also include an ID unit such as 112, which forms a unique ID. The ID unit may be part of the processor and form a processor ID. According to one embodiment, the decryption may be keyed to the processor ID 112, to prevent pirating.

The update sent over the wireless or over the network connection 116 may include updates to the game, and may be stored as part of the game. These may be stored in an encrypted way, or may be stored unencrypted. According to one embodiment, the updates may be keyed to the ID 112, so that each update can only be received and used by the computer that has that ID. According to another embodiment, updates can only be obtained when an appropriately coded dongle is present.

In the embodiment of FIG. 1A, the digital file, e.g., the game, is stored into the storage unit 106. In one embodiment, the game is put on a media device, e.g. a DVD or USB stick. It is difficult to individualize CDs or DVDs, so all of them are made precisely the same. The dongle may be distributed together with the game or seperately. For example, the game may be distributed as a CD that includes the game, along with a dongle that can be used to decode the game. The games may all be the same, but may be individualized once installed. According to another embodiment disclosed herein, the games are sent via network to all computers, so that each storage unit 106 in each of the different computers have all possible games or some subset of games specified according to user parameters. Once these games are saved in the storage unit, the user can purchase decryption keys for the games that they want to play.

In an embodiment, the decryption key can be on a dongle, that can used on any of multiple different computers to play the cryptographically protected games. The decryption key can be used than on any computer that has these games. In this embodiment, a user with the proper decryption key can play the encrypted game on any computer that has the encrypted game.

Another embodiment attempts to protect the decryption key by making only certain allowable crypto codes. For example, the game 106 may be encrypted in a way that allows it to be decrypted by any of many different decryption codes, such as that described in U.S. Pat. No. 7,233,669. If a specific decryption code is compromised, then that decryption code can be deactivated, by sending an update to the program. That update can deactivates the compromised decryption code. Users who are registered will automatically receive an allowable decryption code.

According to one embodiment shown in FIG. 3, the dongle function can be carried out using a user's individual communication device such as PDA or smart phone as a storage unit for the codes. The dongle codes can be sent via wireless communication 410 to the computer console 100. In this embodiment, the computer console may have a hard drive shown as 420 that stores a number of playable games. The computer console 100 in this embodiment is wireless enabled to receive the wireless signal. It can also receive for example WiMAX, cellular, or other signals 415 that include the dongle/authorization information.

The console 100 may be initialized with a number of different games on the hard drive, and then periodically updated to include more games. A user who uses the console is immediately presented with a number of different options for playing games that were pre-stored on the hard drive and those that were downloaded. The console may also have the capability to receive media such as a DVD that includes new games. For example, the DVDs with the new games may be periodically sent to the console owner and games from the DVD can be stored to the hard drive.

This embodiment relies on the low cost of nonvolatile memory such as hard drives. At the time of writing this application, a 750 GB hard drive can be purchased for around $100. A 750 Gb hard drive can store 30 or 40 games. Larger hard drives may be able to store more games. According to another embodiment, the user can set their preferences of what kinds of games or what actual games that they want. For example, the display 120 may include the ability to select the games that the user wants, and these games may then be downloaded. The user may be allowed to play these games for a certain amount of time before the encryption prevents further playing. In one embodiment, for example, the user can play one or two levels of the game before encryption prevents playing the other levels of the game. In an embodiment, as in the other embodiments, the games in the hard drive are cryptographically stored in a way that they cannot be played unless the dongle, here the smart phone, is present.

Another embodiment may allow use of a temporary decryption key that works to decrypt the game for only a limited time.

Another embodiment may allow the games to be played from a removable media such as a DVD. The games on the DVD in this embodiment, however, are also stored encrypted so that the user cannot play these games unless the dongle is present.

The dongle codes can be stored in a removable memory 402 associated with the phone. These dongle codes, however, can also be stored within the phone memory itself.

Another embodiment, which is a lower security embodiment, may store the decryption keys in the crypto unit 108. These decryption keys may then be used to decrypt a game in order to play it. However, in this embodiment, the unit may be locked against using these crypto keys unless it detects that the smart phone 400 is present.

Any of these embodiments can be used with a system that stores the encrypted media on a hard drive, or with an externally provided encrypted media, or with both.

Any of these embodiments can use a decryption key that can be individualized to the console itself, or can be individualized to a dongle that the user must possess in order to use this the game or console, or may be keyed to a biometric of the user. In any of these embodiments, the item is encrypted, and the key is used to decrypt the item.

Different embodiments disclosed above have described a one time use key that can be used once and not used again. Another key may be required to be present in an external device such as a dongle. This external device could also be a smart phone, which stores multiple different keys. Another embodiment may store the keys into a controller 430 that is connected to the gaming system for example. The controller 430 may store all the dongle keys, and moving the controller to different places allows the controller to be used to decode any of the keys with which it is associated.

Personalization of the key may be used. The key can be personalized to a specific console. A biometric can be used as the personalization, so that a user can play the game on any console. Another personalization may be to location—a location sensor such as a GPS device can determine a location of the console, and require that the device be within a certain distance of that location as part of the playback. Another personalization may key to an electronic device, e.g., a cell phone, dongle or controller, which needs to be present in order to decrypt the file.

A biometric of the user may also be used as the dongle, especially in the one-time use embodiment. According to another embodiment, multiple different techniques are used to protect the game. The biometric may be used to unlock the decryption, e.g., as a supplemental part of a multiple part decryption key.

According to another embodiment, a user may automatically obtain certain keys periodically. For example, this may provide game of the month or Book-of-the-Month clubs, so that the user automatically has some games they could play.

Another embodiment allows the user to obtain a decryption key electronically to unlock content which has been stored on their hard drive but yet cannot be read by the user.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

For example, any kind of encryption can be used, such as public/private key encryption; RSA encryption; or any other. Another embodiment may operate over a wholly internet and/or wireless system, or other kinds of gaming systems. er game.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A computer system, comprising:
a computer system; and
a storage part, storing multiple encrypted file sets, each file set including one or more files that collectively forms a playable item that is interactive based on inputs to said computer system, and where said playable item is controlled by a user to change characteristics of a displayed output, and where said encrypted file sets produce outputs based on said controls, where the computer system cannot play a complete playable file set without a personalized decryption key associated with said encrypted file set, wherein said personalized decryption key is specific to at least one file set on said computer system and will not decrypt the same said file set on another computer system,
wherein said computer system includes a cryptographic processing part on said computer system, that personalizes an unpersonalized decryption key to form a personalized decryption key, and wherein said file sets cannot be played without said personalized decryption key and a detection of an indicia of said personalization.

2. A system as in claim 1, wherein said computer system can play a portion of the file set without said decryption key.

3. A system as in claim 1, wherein said personalization associates said decryption key with a biometric of a user, and only allows playing said file sets when said user is detected.

4. A system as in claim 1, wherein said personalization associates said decryption key with an identification of a specific computer, and only allows said specific computer to play said file sets.

5. A system as in claim 1, wherein said computer system includes a reading part that reads a decryption key from an external device.

6. A system as in claim 5, wherein said reading part reads said decryption key wirelessly.

7. A system as in claim 6, wherein said computer system includes a reading part that reads a decryption key and personalizes said decryption key, and said cryptographic processing part that prevents said decryption key on said external device from being personalized more than once.

8. A system as in claim 1, wherein said file sets are computer based games, and further comprising a game controller that controls said interaction with said game.

9. A game console, comprising:
a storage part, storing multiple encrypted file sets indicative of games, each file set including one or more files that collectively forms an interactive game;
a computer system, decrypting an encrypted portion of said encrypted file sets and controlling playing a game based on the decrypted file;
wherein said computer system includes a cryptographic processing part on said computer system, that decrypts said encrypted portions to allow playing the games.

10. A console as in claim 9, wherein said where said computer system reads a decryption key from an external device.

11. A console as in claim 9, wherein said cryptographic processing part operates to personalize a first decryption key to create a second personalized decryption key, in a way that allows said second decryption key to be used only for playing said games only when said personalization is satisfied.

12. A console as in claim 11, wherein said personalization associates said decryption key with a biometric of a user, and only allows playing said file sets when said user is detected.

13. A console as in claim 11, wherein said personalization associates said decryption key with an identification of a specific console, and only allows playing said file sets when said console is detected.

13. A console as in claim 11, wherein said personalization associates said decryption key with an identification of a specific electronic device, and only allows playing said file sets when said specific electronic device is detected.

13. A console as in claim 11, wherein said personalization associates said decryption key with an identification of a specific location, and only allows playing said file sets when said location is detected.

14. A console as in claim 11, wherein said cryptographic processing part includes a reading part that reads said first decryption key and personalizes said first decryption key to create said second decryption key, and said cryptographic processing part that prevents said first decryption key from being personalized more than a specified number of times.

15. A game console, comprising:
a file reading part, storing one or more encrypted files that collectively forms an interactive game; and
a computer system, including a port that receives a signal from an external device, and allows decrypting an encrypted portion of said encrypted file sets only when said signal is present, and controlling playing a game based on the decrypted file.

16. A console as in claim 15, wherein said port receives said signal wirelessly.

17. A console as in claim 15, wherein said signal includes a decryption key.

18. A console as in claim 15, wherein said signal includes information indicative of a unique device, without which a decryption key cannot be used.

19. A console as in claim 18, wherein said unique device is a portable telephone and said computer system detects a specific portable phone, and allows decrypting an encrypted portion of said encrypted file sets only when said specific portable phone is present.

20. A console as in claim 15, wherein said computer includes a cryptographic processing part that reads a first decryption key and personalizes said first decryption key to create a second decryption key, and said cryptographic processing part that prevents said first decryption.
